(19) United States
(12) Patent Application Publication
(10) Pub. No.: US 2016/0186956 A1
(43) Pub. Date: Jun. 30, 2016

(54) VEHICLE LIGHTING DEVICE AND FABRICATION METHOD THEREOF

(71) Applicant: CORETRONIC CORPORATION, HSIN-CHU (TW)

(72) Inventors: CHAO-NAN CHIEN, HSIN-CHU (TW); TZU-TSE HUANG, HSIN-CHU (TW); JYUN-LIN LAI, HSIN-CHU (TW)

(21) Appl. No.: 14/741,876

(22) Filed: Jun. 17, 2015

(30) Foreign Application Priority Data
Dec. 26, 2014 (TW) 103145727

(51) Int. Cl. F21S 8/10

(52) U.S. Cl. CPC F21S 48/328; F21Y 2101/02

(57) ABSTRACT

A vehicle lighting device includes lamp housing, a heat sink, a light source assembly, and a flexible member. The heat sink is disposed inside the lamp housing, and the light source assembly is disposed on the heat sink. The flexible member is inserted between and in contact with the heat sink and the lamp housing to form a heat conduction path through the heat sink, the flexible member and the lamp housing.

### BACKGROUND OF THE INVENTION

a. Field of the Invention

The invention relates generally to a lighting device, and more particularly, to a vehicle lighting device having improved heat dissipation efficiency.

b. Description of the Related Art

FIG. 1 shows a schematic diagram of a conventional vehicle lighting device. As illustrated in FIG. 1, multiple flanges 102a are formed inside a lamp housing 102 of a vehicle lighting device 100 by spot welding. After a light source assembly 104 is mounted on a heat sink 106, the heat sink 106 is fixed at the flanges 102a of the lamp housing 102. Heat in the heat sink 106 is transferred to the entire lamp housing 102 merely by the flanges 102a having tiny contact areas to result in inferior heat dissipation.

Taiwan utility model patent No. M482521 discloses a vehicle lamp structure having an illumination unit, a heat-dissipation unit and a waterproof cover. The illumination unit includes a mount, a lens and a light-emitting element. The heat-dissipation unit includes a heat-dissipation chassis and a heat-dissipation cover, and the heat-dissipation chassis cooperates with the heat-dissipation cover to clip the waterproof cover. China utility model patent No. 2025812220 discloses a lamp with a heat-dissipation structure including a lamp holder, a heat-dissipation cover, a lamp bracket and a lighting device. The lighting device is mounted on the lamp bracket, and heat generated by the lighting device is dissipated into the ambient environment via the heat-dissipation cover. The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### BRIEF SUMMARY OF THE INVENTION

The invention provides a vehicle lighting device having improved heat dissipation efficiency.

Other objects and advantages of the invention may be further illustrated by the technical features broadly embodied and described as follows.

In order to achieve one or a portion of or all of the objects or other objects, one embodiment of the invention provides a vehicle lighting device including a lamp housing, a heat sink, a light source assembly, and a flexible member. The heat sink is disposed inside the lamp housing, and the light source assembly is disposed on the heat sink. The flexible member is inserted between and in contact with the heat sink and the lamp housing to form a heat conduction path through the heat sink, the flexible member and the lamp housing.

In one embodiment, the flexible member leans against the lamp housing and supports the heat sink and the light source assembly.

In one embodiment, the flexible member may include multiple separate resilient sheets or a bending sheet having multiple slots.

In one embodiment, the heat sink has multiples fins and slots, each of the slots is defined by two adjacent fins, and the flexible member is fit in at least one of the slots to hold the flexible member on the heat sink.

In one embodiment, the flexible member may be made of metal, a thermal conductivity of the flexible member is larger than 50 W/mK, and an average thickness of the flexible member is larger than 0.8 mm.

In one embodiment, the flexible member has an annular shape, and a contact surface of the flexible member touching the lamp housing has an annular shape.

In one embodiment, the light source assembly includes a light-emitting element and an optical element. The light-emitting element is fixed on the heat sink and capable of emitting a light beam, and the optical element is located in a propagation path of the light beam and transmits the light beam to produce a light pattern.

In one embodiment, the heat sink has a central portion and a peripheral portion outside the central portion, the central portion supports the light-emitting element, and the peripheral portion may have at least one slot. The flexible member may be fit in the slot or may cover one side of the central portion facing away from the light source assembly.

In one embodiment, a vehicle lighting device further comprises a lamp cover. The lamp cover is aligned with and coupled to the lamp housing. The heat sink is secured to the lamp cover.

Another embodiment of the invention provides a fabrication method of a vehicle lighting device. To fabricate a vehicle lighting device, a light-emitting element may be secured to a heat sink, a flexible member may be fit in the heat sink, and the heat sink and the light-emitting element may be put in a lamp housing to allow the flexible member to touch the heat sink and the lamp housing. The heat sink may be secured to a lamp cover, and the lamp cover may be secured to the lamp housing.

According to the above embodiments, the flexible member that may lean against the lamp housing and support the heat sink forms a contact surface with the heat sink and a contact surface with the lamp housing. Therefore, a heat conduction path through the heat sink, the flexible member and the lamp housing is formed to enhance heat dissipation. Compared with the conventional design where a heat sink forms a point contact to each flange of a lamp housing, the flexible member formed as a separate piece allows greater thickness and more contact areas (such as having an annular shape) to increase the heat dissipation efficiency. Further, in the conventional design, the flanges are integrally formed on the lamp housing and thus are made of the same martial (normally iron) as the lamp housing. Therefore, the material of the flanges that conduct heat cannot be independently selected to thus fail to further improve the heat dissipation efficiency. In comparison, because the flexible member that conducts heat is formed as a separate piece to provide a wide selection of materials, the flexible member can be made of a material having a high thermal conductivity such as aluminum or copper to further enhance heat dissipation.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional vehicle lighting device.

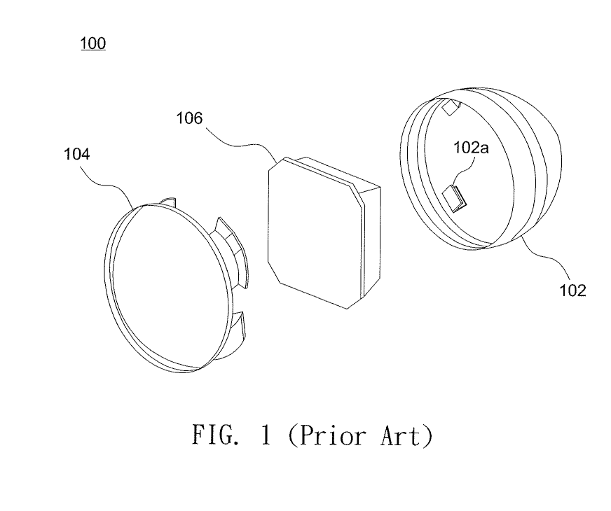

FIG. 2 shows an exploded view of a vehicle lighting device according to an embodiment of the invention.

FIG. 3 is a schematic cross-section of the assembled vehicle lighting device shown in FIG. 2.

FIG. 4 shows an exploded view of a vehicle lighting device according to another embodiment of the invention.

FIG. 5 shows an schematic diagram of a vehicle lighting device according to another embodiment of the invention.

FIGS. 6A to 6C show schematic diagrams illustrating various embodiments of a flexible member.

FIG. 7 shows a flow chart illustrating an exemplary method for fabricating a vehicle lighting device.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

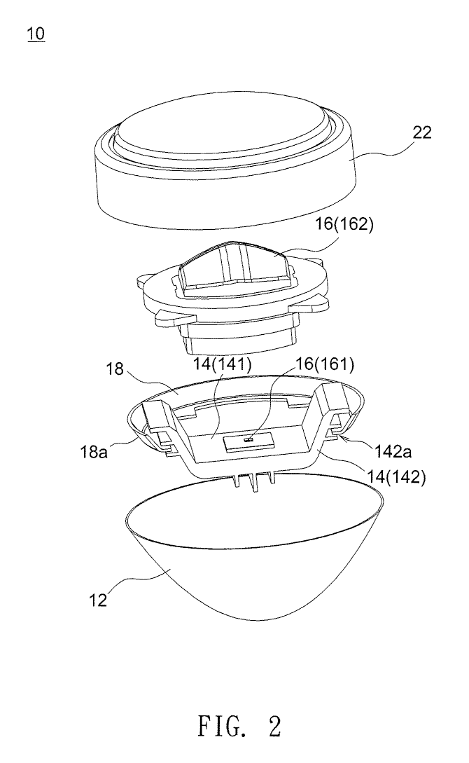

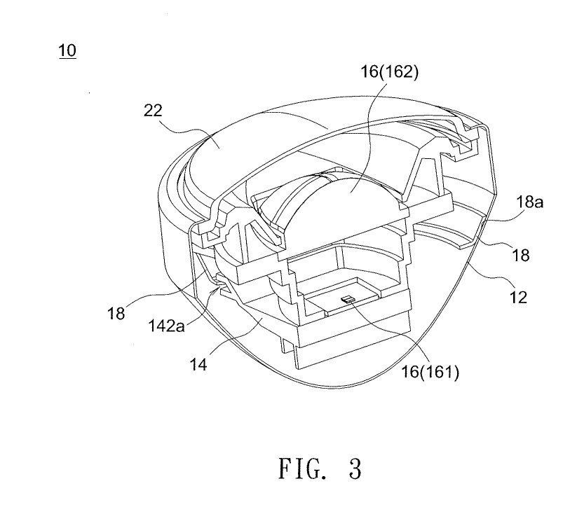

FIG. 2 shows an exploded view of a vehicle lighting device according to an embodiment of the invention. FIG. 3 is a schematic cross-section of the assembled vehicle lighting device shown in FIG. 2. As illustrated in FIG. 2 and FIG. 3, a vehicle lighting device 10 includes a lamp housing 12, a heat sink 14, a light source assembly 16 and a flexible member 18. The heat sink 14 is disposed inside the lamp housing 12, and the light source assembly 16 is disposed on the heat sink 14. The light source assembly 16 may include at least a light-emitting element 161 and an optical element 162, the light-emitting element 161 is fixed on the heat sink 14 and capable of emitting a light beam, and the optical element 162 is located in a propagation path of the light beam. The optical element 162 that transmits the light beam is configured to produce a desired light pattern for the vehicle lighting device 10. The flexible member 18 is, through its flexible characteristic, inserted between and in contact with the heat sink 14 and the lamp housing 12 to form a heat conduction path through the heat sink 14, the flexible member 18 and the lamp housing 12. That is, heat generated by the light source assembly 16 can be quickly transferred to the lamp housing 12 via the heat sink 14 and the flexible member 18 to dissipate heat into the ambient environment. The flexible member 18 may lean against the lamp housing 12 and may support the heat sink 14 and the light source assembly 16. A lamp cover 22 may be aligned with and coupled to the lamp housing 12, and the heat sink 14 may be secured to the lamp cover 22. In this embodiment, the heat sink 14 has a central portion 141 and a peripheral portion 142 outside the central portion 141. The central portion 141 supports the light-emitting element 161, and the peripheral portion 142 has at least one slot 142a. The flexible member 18 is fit in the slot 142a to support the heat sink 14 and the light source assembly 16.

In one embodiment, the flexible member 18 may have a thermal conductivity of larger than 50 W/mK, and the flexible member 18 may be made of iron or made of aluminum or copper having a higher thermal conductivity. The flexible member 18 may have an annular shape to thus form an annular contact surface that is on the flexible member 18 and in contact with the lamp housing 12, with the annular shape being beneficial to increase a contact area between the flexible member 18 and the lamp housing 12. Moreover, heat can be more efficiently transferred to the lamp housing 12 to further enhance heat dissipation as the flexible member 18 becomes thicker. In one embodiment, an average thickness of the flexible member 18 may be larger than 0.8 mm. In one embodiment, the light-emitting element 161 may include, but is not limited to, a solid-state light source such as a light-emitting diode or a laser light source.

According to the above embodiments, the flexible member 18 that may lean against the lamp housing 12 and support the heat sink 14 forms a contact surface with the heat sink 14 and a contact surface with the lamp housing 12. Therefore, a heat conduction path through the heat sink 14, the flexible member 18 and the lamp housing 12 is formed to enhance heat dissipation efficiency. Compared with the conventional design where a heat sink forms a point contact to each flange of a lamp housing, the flexible member 18 formed as a separate piece allows greater thickness and more contact areas (such as having an annular shape) to increase the heat dissipation efficiency. Further, in the conventional design, the flanges are integrally formed on the lamp housing and thus are made of the same martial (normally iron) as the lamp housing. Therefore, the material of the flanges cannot be independently selected to thus fail to further improve the heat dissipation efficiency. In comparison, because the flexible member 18 is formed as a separate piece to provide a wide selection of materials, the flexible member 18 can be made of a material having a high thermal conductivity such as aluminum or copper to further enhance heat dissipation.

Based on results of experiments in another embodiments, under the condition where light-emitting element is a light-emitting diode with a power of 9.6 W and the room temperature is 23° C., the light-emitting element 161 and heat sink 14 can be both reduced by at least 40 degrees Celsius as the flexible member 18 is provided. This is clearly demonstrated in the experiments in which heat can be quickly transferred from the heat sink 14 to the lamp housing 12 by the use of the flexible member 18.

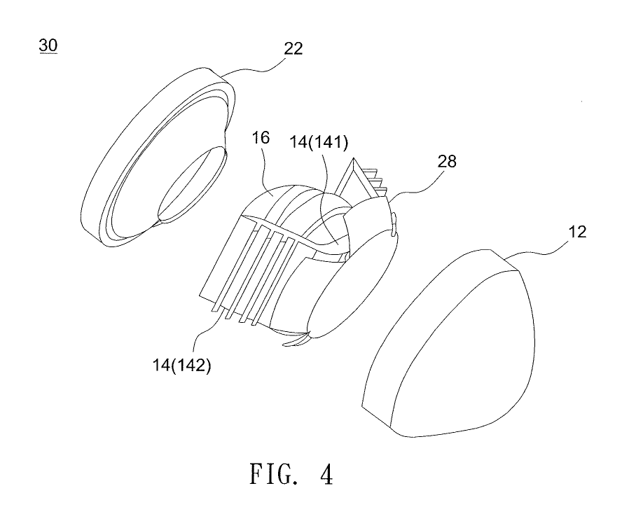

As illustrated in FIG. 4, in an alternate embodiment, a heat sink 14 of a vehicle lighting device 30 has a central portion 141 and a peripheral portion 142 outside the central portion 141, and the central portion 141 supports a light-emitting element (not shown). Unlike FIG. 2 where the flexible member 18 is fit in the slot 142a of the peripheral portion 142, a flexible member 28 shown in FIG. 4 is disposed between the heat sink 14 and the lamp housing 12 to cover one side of the central portion 141 facing away from a light source assembly 16. Similarly, a heat conduction path through the heat sink 14, the flexible member 28 and the lamp housing 12 is formed to enhance heat dissipation. Besides, in this embodiment, the manner that the flexible member 28 covers the bottom of the heat sink 14 may help to increase a contact area between the flexible member 28 and the lamp housing 12.

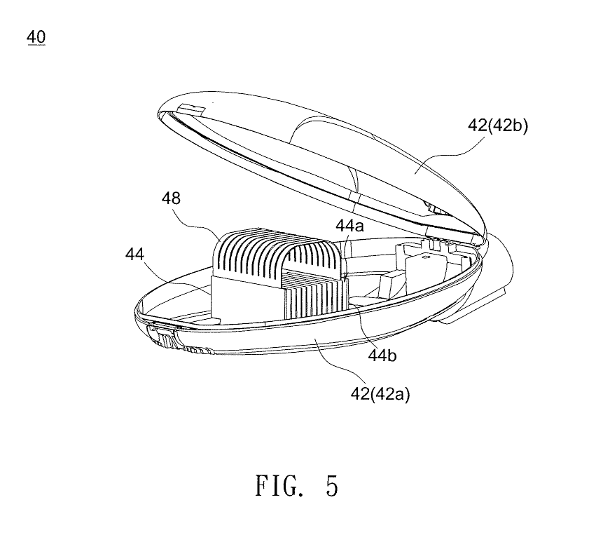

FIG. 5 shows a schematic diagram of a vehicle lighting device according to another embodiment of the invention. As illustrated in FIG. 5, a lamp housing 42 of a vehicle lighting device 40 includes a bottom part 42a and a top part 42b. A heat sink 44 is disposed on the bottom part 42a of the lamp housing 42 and has multiples slots 44a and fins 44b, and each slot 44a is defined by two adjacent fins 44b. It means that the slot is a space between the two adjacent fins. A flexible member 48 is fit in at least one slot 44a of the heat sink 44 to hold the flexible member 48 on the heat sink 44. When the bottom part 42a and the top part 42b of the lamp housing 42 are aligned and pressed, the flexible member 48 may touch the top part 42b of the lamp housing 42 to similarly form a heat conduction path through the heat sink 44, the flexible member 48 and the lamp housing 42.

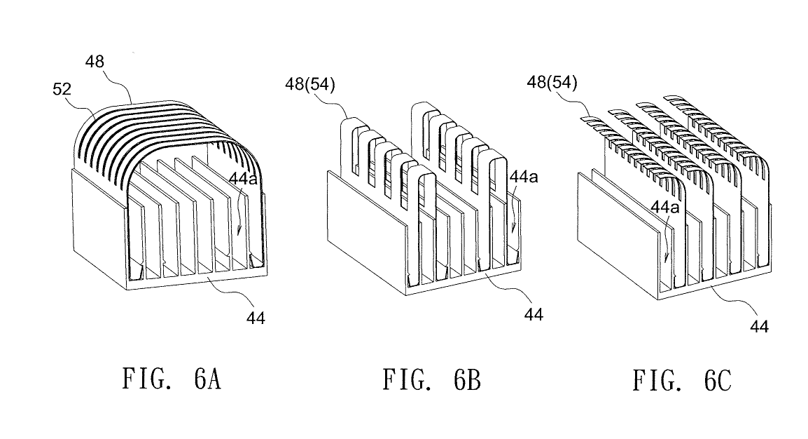

FIGS. 6A to 6C show schematic diagrams illustrating various embodiments of a flexible member. Referring to FIG. 5 and FIGS. 6A to 6C, the flexible member 48 is not limited to a specific shape. For example, as shown in FIG. 6A, the flexible member 48 may be in the shape of a bending sheet having multiple slots 52. Alternatively, as shown in FIG. 6B and FIG. 6C, the flexible member 48 may include multiple separate resilient sheets 54 fit in the slots 44a of the heat sink 44, and thus a contact area between the flexible member 48 and the lamp housing 42 can be increased by increasing the number of the resilient sheets 54. Further, a single resilient sheet 54 may be fit in different slots 44a or one slot 44a.

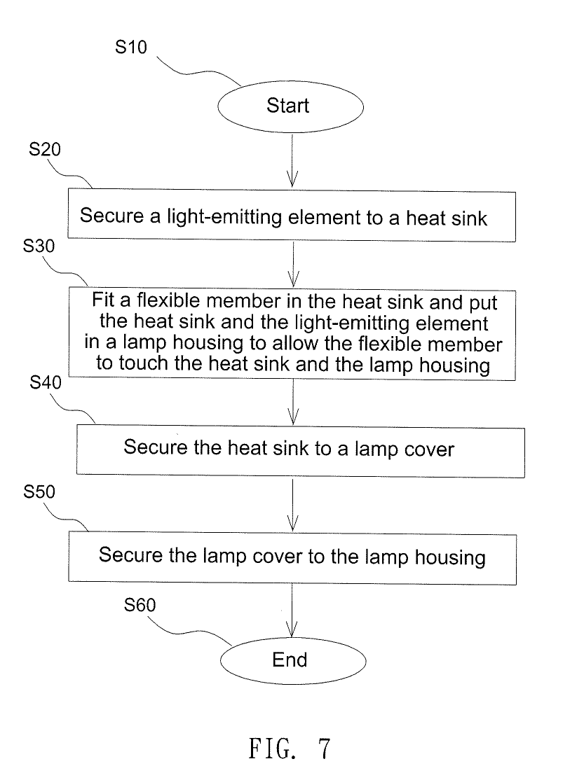

FIG. 7 illustrates an exemplary method for fabricating a vehicle lighting device. A light-emitting element can be secured to a heat sink (Step S20). A flexible member can be fit in the heat sink, and the heat sink and the light-emitting element can be put in a lamp housing to allow the flexible member to touch the heat sink and the lamp housing (Step S30). The heat sink can be secured to a lamp cover (Step S40), and the lamp cover can be secured to a lamp housing (Step S50). It should be apparent that the fabrication method shown in FIG. 7 is one example of fabricating a vehicle lighting device, and that the vehicle lighting device can be made by other fabrication or assembling processes without restriction.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A vehicle lighting device, comprising:
a lamp housing;
a heat sink disposed inside the lamp housing;
a light source assembly disposed on the heat sink; and
a flexible member being inserted between and in contact with the heat sink and the lamp housing to form a heat conduction path through the heat sink, the flexible member and the lamp housing.

2. The vehicle lighting device as claimed in claim 1, wherein the flexible member leans against the lamp housing and supports the heat sink and the light source assembly.

3. The vehicle lighting device as claimed in claim 1, wherein the flexible member is made of metal.

4. The vehicle lighting device as claimed in claim 1, wherein the flexible member has an annular shape, and a contact surface of the flexible member touching the lamp housing has an annular shape.

5. The vehicle lighting device as claimed in claim 1, wherein the flexible member comprises multiple separate resilient sheets.

6. The vehicle lighting device as claimed in claim 1, wherein the flexible member is a bending sheet having multiple slots.

7. The vehicle lighting device as claimed in claim 1, wherein a thermal conductivity of the flexible member is larger than 50 W/mK, and an average thickness of the flexible member is larger than 0.8 mm.

8. The vehicle lighting device as claimed in claim 1, wherein the light source assembly comprises:
a light-emitting element fixed on the heat sink and capable of emitting a light beam; and
an optical element located in a propagation path of the light beam and transmitting the light beam to produce a light pattern.

9. The vehicle lighting device as claimed in claim 8, wherein the heat sink has a central portion and a peripheral portion outside the central portion, the central portion supports the light-emitting element, the peripheral portion has at least one slot, and the flexible member is fit in the slot.

10. The vehicle lighting device as claimed in claim 8, wherein the heat sink has a central portion and a peripheral portion outside the central portion, the central portion supports the light-emitting element, and the flexible member covers one side of the central portion facing away from the light source assembly.

11. The vehicle lighting device as claimed in claim 1, wherein the heat sink has multiples fins and slots, each of the slots is defined by two adjacent fins, and the flexible member is fit in at least one of the slots to hold the flexible member on the heat sink.

12. The vehicle lighting device as claimed in claim 1, wherein the light-emitting element comprises a light-emitting diode or a laser light source.

13. The vehicle lighting device as claimed in claim 1, further comprising:
a lamp cover aligned with and coupled to the lamp housing, wherein the heat sink is secured to the lamp cover.

14. A fabrication method of a vehicle lighting device, comprising the steps of:
securing a light-emitting element to a heat sink;
fitting a flexible member in the heat sink and putting the heat sink and the light-emitting element in a lamp housing, wherein the flexible member touches the heat sink and the lamp housing;
securing the heat sink to a lamp cover; and
securing the lamp cover to the lamp housing.
